(19) United States
(12) Patent Application Publication
(10) Pub. No.: US 2024/0291584 A1
(43) Pub. Date: Aug. 29, 2024

(54) Management Device, Battery Data Transmission Device, and Transmission System

(71) Applicant: Hitachi Astemo, Ltd., Hitachinaka-shi, Ibaraki (JP)

(72) Inventors: Yoshimi NOGUCHI, Tokyo (JP); Masahiro KAGEYAMA, Tokyo (JP); Takanori YAMAZOE, Tokyo (JP); Mutsumi KIKUCHI, Hitachinaka-shi (JP)

(21) Appl. No.: 18/564,851

(22) PCT Filed: Mar. 3, 2022
(86) PCT No.: PCT/JP2022/009258

§ 371 Date: Nov. 28, 2023

(30) Foreign Application Priority Data
Aug. 18, 2021 (JP) 2021-133675

(51) Int. Cl. H04L 1/00; H02J 7/00; H04L 67/12

(52) U.S. Cl. CPC H04L 1/0002; H02J 7/00032; H04L 67/12; H02J 7/0047

(57) ABSTRACT

A management device includes: a transmission control unit that communicates with a battery data transmission device that transmits encoded data, which is obtained by encoding battery data which is data regarding a battery, via a transmission path; an abnormality detection unit that detects an abnormality of the transmission path; and a command unit that outputs, to the battery data transmission device, a command to shorten a data length of the encoded data when the abnormality detection unit detects the abnormality of the transmission path.

### TECHNICAL FIELD

The present invention relates to a management device, a battery data transmission device, and a transmission system.

### BACKGROUND ART

In a battery system used in a hybrid vehicle, an electric vehicle, or the like, an assembled battery configured by connecting a large number of single battery cells of a secondary battery in series is used. In such an assembled battery, for capacity calculation and protection management of each single battery cell, the single battery cell is managed by using a monitoring IC that monitors a state of the single battery cell and a control IC that controls a charge/discharge state of the single battery cell. Although wired connection is the mainstream for connection between the monitoring IC and the control IC, application of wireless communication has been studied for various reasons such as weight reduction and cost reduction expansion of an in-vehicle space, improvement of a degree of freedom in arrangement, and reduction of a short circuit risk at the time of collision due to reduction of a connection cable (communication harness). On the other hand, the monitoring and control of the battery cell are performed at considerably short intervals (tens of ms to hundreds of ms), and robust communication is required. However, in the vehicle, communication quality deteriorates due to various metals, high currents, and disturbances such as wireless communication of an occupant and the vicinity. PTL 1 discloses a method for compressing/expanding battery data, which saves a current value and a voltage value of a battery at each time as paired data, the method including, during compression of the data, calculating a present current variation prediction value by the use of a variation between preceding and present voltage values, calculating a difference between the present current variation prediction value and an actual variation of a present current value, and saving the difference as data, and, during expansion of the data, calculating a present current variation prediction value by the use of a variation between preceding and present voltage values, and adding a difference between the present current variation prediction value and an actual present current value to the present current variation prediction value to calculate a variation of the present current value.

### CITATION LIST

### Patent Literature

PTL 1: JP 2014-230124 A

### SUMMARY OF INVENTION

### Technical Problem

In the invention described in PTL 1, there is room for improvement in measures against transmission errors.

### Solution to Problem

A management device according to a first aspect of the present invention includes: a transmission control unit that communicates with a battery data transmission device that transmits encoded data, which is obtained by encoding battery data (for example, a voltage, a current, a temperature, a state of charge, a deterioration state, and the like of a single battery cell), which is data regarding a battery, via a transmission path; an abnormality detection unit that detects an abnormality of the transmission path; and a command unit that outputs, to the battery data transmission device, a command to shorten a data length of the encoded data when the abnormality detection unit detects the abnormality of the transmission path.

A battery data transmission device according to a second aspect of the present invention includes: an encoding unit that generates encoded data obtained by encoding battery data that is data regarding a battery; a transmission control unit that transmits the encoded data to a management device via a transmission path; and an abnormality detection unit that detects an abnormality of the transmission path. The encoding unit has at least a first mode and a second mode as operation modes, the encoded data in the second mode has a data length shorter than a data length of the encoded data in the first mode, and the abnormality detection unit applies the second mode to the encoding unit when detecting the abnormality of the transmission path.

A transmission system according to a third aspect of the present invention is a transmission system which includes a battery data transmission device that transmits, via a transmission path, encoded data obtained by encoding battery data which is data regarding a battery, and a management device that receives the encoded data. The transmission system includes an abnormality y detection unit that detects an abnormality of the transmission path. The battery data transmission device includes an encoding unit that generates the encoded data by using the battery data, and a transmission control unit that transmits the encoded data to the management device via the transmission path, the encoding unit has at least a first mode and a second mode as operation modes, the encoded data in the second mode has a data length shorter than a data length of the encoded data in the first mode, and the abnormality detection unit applies the second mode to the encoding unit when detecting the abnormality of the transmission path.

### Advantageous Effects of Invention

According to the present invention, in data encoding for transmitting information of a battery, an encoding method is changed between a normal time and an abnormal time, and transmission of information can be maintained even in a situation where a transmission error occurs.

### BRIEF DESCRIPTION OF DRAWINGS

FIG. 1 is an overall configuration diagram of a transmission system according to a first embodiment.

FIG. 2 is a schematic diagram illustrating transmission data.

FIG. 3 is a flowchart illustrating an operation of a management device.

FIG. 4 is a flowchart illustrating an operation of a battery data transmission device.

FIG. 5 is a flowchart illustrating abnormality detection processing by an abnormality detection unit.

FIG. 6 is a functional configuration diagram of the battery data transmission device in a second modification.

FIG. 7 is an overall configuration diagram of the transmission system according to a second embodiment.

FIG. 8 is a flowchart illustrating processing of the abnormality detection unit in the second embodiment.

FIG. 9 is an overall configuration diagram of the transmission system in a third embodiment.

FIG. 10 is an overall configuration diagram of the transmission system in a fourth embodiment.

### DESCRIPTION OF EMBODIMENTS

### First Embodiment

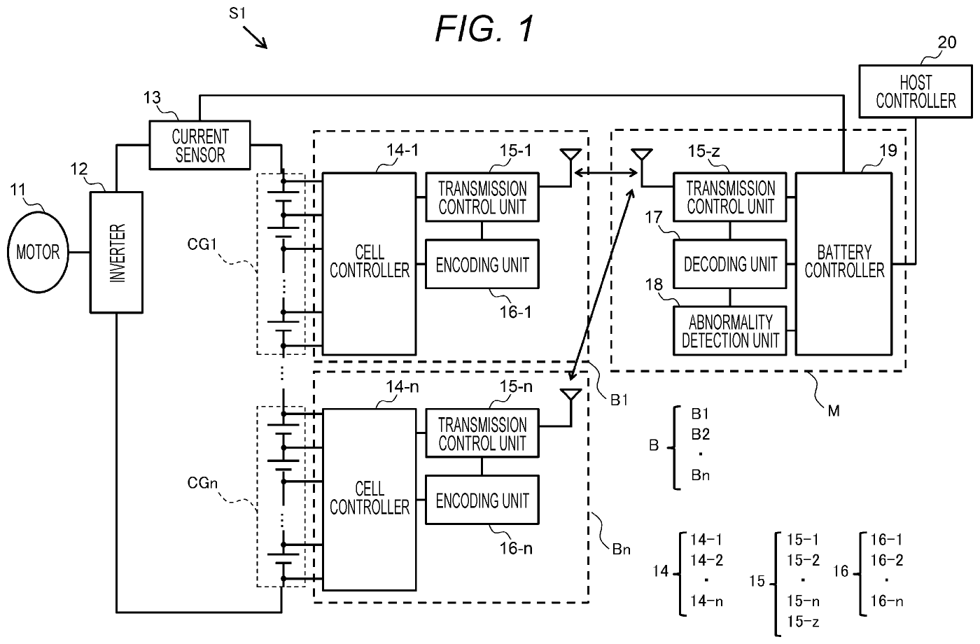

Hereinafter, a first embodiment of a transmission system will be described with reference to FIGS. 1 to 5.

### (Overall Configuration)

FIG. 1 is an overall configuration diagram of a transmission system S1 in the first embodiment. The transmission system S1 includes a motor 11, an inverter 12, a current sensor 13, a plurality of cell groups CG, a plurality of battery data transmission devices B, a management device M, and a host controller 20. The plurality of battery data transmission devices B are identified by branch numbers, respectively. Note that hereinafter, the whole of the plurality of cell groups CG or individual cells included in each cell group CG are also referred to as “batteries”.

The battery data transmission device B includes a cell controller 14, a transmission control unit 15, and an encoding unit 16. The battery data transmission devices B have the same configuration and operation. Hereinafter, a specific operation may be described by using the battery data transmission device B1. That is, hereinafter, the description may be given by using a cell controller 14-1, a transmission control unit 15-1, and an encoding unit 16-1 which are the configurations of the battery data transmission device B1.

The management device M includes a transmission control unit 15-z, a decoding unit 17, an abnormality detection unit 18, and a battery controller 19. The transmission control unit 15-1 and a transmission control unit 15-n, which are transmission control units included in the battery data transmission device B, and a transmission control unit 15-z included in the management device M are connected by a transmission path T. The transmission path T is a space for wireless communication, and the transmission control unit 15 performs wireless communication.

The inverter 12 supplies the electric power stored in the cell group CG to the motor 11, or accumulates the electric power obtained from the motor 11 in the cell group CG. The current sensor 13 measures a current flowing between the inverter 12 and the cell group CG and transmits the result to the battery controller 19.

The cell controller 14, the encoding unit 16, the decoding unit 17, the abnormality detection unit 18, and the battery controller 19 are, for example, any of a computer, a field programmable gate array (FPGA), and an application specific integrated circuit (ASIC) which is an application specific integrated circuit. The computer includes a CPU which is a central processing unit, a ROM which is a read-only storage device, and a RAM which is a readable/writable storage device, and the CPU performs various calculations by developing, in the RAM, a program stored in the ROM and executing the program.

The cell controller 14 controls the cell group CG in which a plurality of cells are put together. The cell controller 14 performs control designated by the management device M via the transmission path T. The cell controller 14 includes at least a voltmeter and measures a voltage of each cell. The cell controller 14 includes other sensors, and for example, each cell temperature may be measurable. The cell controller 14 may calculate a state of charge (SoC) of each battery. When receiving a request command to be described later from the management device M, the cell controller 14 transmits information of the connected cell group. The request command includes designation of an encoding mode, and the cell controller 14 outputs information of the designated encoding mode and information of the cell group CG to the encoding unit 16.

The transmission control unit 15-1 and the transmission control unit 15-n included in the battery data transmission device B transmit, to the management device M, the information encoded by the encoding unit 16. In addition, the transmission control unit 15-1 and the transmission control unit 15-n output, to the cell controller 14, the information received from the management device M. The transmission control unit 15-z included in the management device M outputs, to the decoding unit 17, the information received from the battery data transmission device B. The transmission control unit 15 is a communication module.

The encoding unit 16 encodes the information of the cell group CG output from the cell controller 14 in the designated encoding mode, and outputs the result to the transmission control unit 15. The encoding unit 16 has a plurality of encoding modes and operates in the encoding mode designated by the cell controller 14. The decoding unit 17 decodes the information of the cell group CG received from the battery data transmission device B and outputs the result to the abnormality detection unit 18 and the battery controller 19.

The abnormality detection unit 18 detects an abnormality occurring in the transmission path T. Details of the abnormality detection will be described later. The battery controller 19 controls charging and discharging of the battery, that is, the cell group CG according to an instruction of the host controller 20. In addition, the battery controller 19 also transmits, to the host controller 20, whether or not the battery is in a normal state. The battery controller 19 transmits, to each cell controller 14, a request command for requesting transmission of the battery data every time a predetermined time, for example, 20 ms elapses. The request command includes information designating an encoding mode. The cell controller 14 acquires battery data, performs encoding in a designated mode to obtain encoded data, and transmits the encoded data to the management device M. The mode may be the same for all the cell controllers, or may be changed for each cell controller. Note that the battery data is, for example, a voltage, a current, a temperature, a state of charge, a deterioration state, and the like of the single battery cell.

### (Abnormality Detection Unit)

The abnormality detection unit 18 detects the abnormality of the transmission path T by using a data reception interval, the number of times of retransmission request, a reception level, and a data error. As the data error, an existing error detection code (for example, CRC or the like) or error correction code (for example, a block code such as a Reed-Solomon code, a convolutional code, a concatenation code, and the like) may be used. Each will be described below.

In a case where the abnormality detection is performed by using the data reception interval, the abnormality detection unit 18 determines that an abnormality has occurred in the transmission path T in a case where the interval of the time when the transmission control unit 15-3 receives the data from each battery data transmission device B is longer than a threshold. Since the battery controller 19 transmits the request command to each battery data transmission device B at predetermined time intervals, if communication is normally performed, the request command is obtained after an extremely short time. Therefore, the abnormality detection unit 18 determines that an abnormality has occurred in the transmission path T since the interval of the time for receiving the request command is longer than the threshold.

The threshold may be a predetermined fixed value or a value calculated on the basis of the acquired battery information. In general, the ranges of a normal voltage and a state of charge (SoC) are determined for a cell, and these pieces of information may be used. For example, the abnormality detection unit 18 may determine the threshold by using the latest SoC and the amount of current flowing through the cell. For example, in a case where the SoC acquired 1 second ago is 45% and the SoC acquired this time is 44%, the SoC decreases at a rate of 1% in 1 second. Therefore, assuming that the lower limit of the SoC is 30%, the SoC reaches the limit about 15 seconds later. In this case, the abnormality detection unit 18 may set the threshold of the data reception interval to 15 seconds or a value (for example, 1.5 seconds in a case where the coefficient is 0.1) obtained by multiplying 15 seconds by a certain coefficient. In addition, in a case where the amount of current is used, by calculating an integral value of the observed amount of current and converting the integrated value into the Soc, the time to reach the set SoC or the upper and lower limits of the voltage may be estimated, and the threshold may be calculated on the basis of the estimated time. In addition, a plurality of thresholds may be set by a plurality of coefficients and the like, and the encoding method and the transmission data may be changed according to each threshold.

In a case where the abnormality detection is performed by using the number of times of retransmission request, the abnormality detection unit 18 determines that an abnormality has occurred in the transmission path T in a case where the number of times of retransmission request per unit time is larger than a predetermined threshold. The retransmission request may be a request from the battery data transmission device B to the management device M, or may be a request from the management device M to the battery data transmission device B. Further, the retransmission request may occur at a level of a communication protocol, for example, at or below the sixth layer in an OSI reference model, or may occur at an application layer.

In a case where the abnormality detection is performed by using the reception level, the abnormality detection unit 18 determines that an abnormality has occurred in the transmission path T in a case where a current level when any radio wave is observed becomes smaller than a predetermined threshold in the wireless communication between the management device M and the battery data transmission device B. In addition, in a case where the abnormality detection is performed by using an existing error detection method, for example, a CRC error, the abnormality detection unit 18 calculates a cyclic redundancy check (CRC) of the data received from the battery data transmission device B, and determines that an abnormality has occurred in the transmission path T in a case where the CRC error has occurred or in a case where the number of occurrences exceeds a predetermined threshold.

### (Encoding Mode)

The encoding mode includes two modes of a normal mode and an abnormal mode. The operation in the normal mode and the operation in the abnormal mode are not limited to specific operations, and it is sufficient if a data length is shorter in the abnormal mode than in the normal mode. A typical operation of each mode will be described below. The information of the cell transmitted by the cell controller 14 is not limited to the information of the voltage, but only the transmission of the voltage will be described here for brevity. Hereinafter, the normal mode may be referred to as a “first mode”, and the abnormal mode may be referred to as a “second mode”.

The encoding unit 16 of the cell controller 14 designated to operate in the normal mode may use, as encoded data, a list of the latest values of the voltages of the respective cells, may use, as encoded data, a difference from past measured values, or may use, as encoded data, a difference from a reference cell in the cell group CG. Instead of using the numerical value as the encoded data as it is, the cell controller 14 may use the encoded data obtained by using the variable-length encoding using the known entropy, for example, the Huffman encoding or the context-adaptive encoding (CAVLC, CABAC, or the like). In the case of performing encoding based on a table created in advance, such as Huffman encoding, it can be said that the encoding unit 16 performs compression processing of compressing the battery data into encoded data having a data length equal to or less than that of the battery data.

The cell controller 14 designated to operate in the abnormal mode may transmit only the values of the minimum voltage and the maximum voltage among the voltages of the cells included in the cell group CG, or may transmit the value of the minimum voltage, the value of the maximum voltage, the identifier of the cell of the minimum voltage, and the identifier of the cell of the maximum voltage. In addition, the cell controller 14 designated to operate in the abnormal mode may transmit the voltage values of all the cells with rougher accuracy than in the normal mode.

### (Transmission Data)

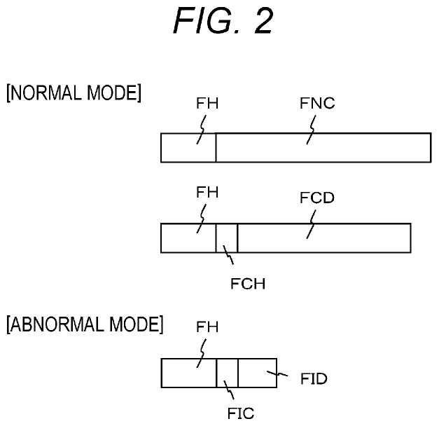

FIG. 2 is a schematic diagram illustrating the transmission data transmitted by the transmission control unit 15 of the battery data transmission device B in the normal mode and the abnormal mode. In any of the modes, a communication header FH is included at the head of the transmission data. The communication header FH is information indicating a destination of transmission data, and is, for example, an IP address or a CAN-ID. In the normal mode, subsequent to communication header FH, uncompressed data FNC may be stored, or an encoding header FCH and normal-time encoded data FCD may be included. The uncompressed data FNC is obtained by arranging information on a battery without compressing the information, and is, for example, obtained by sequentially describing voltage values of cells.

The encoding header FCH is information, such as a compression method and a data length, necessary for interpreting the normal-time encoded data FCD. The normal-time encoded data FCD is obtained when the battery data is encoded by using the encoding header FCH. For example, a case is assumed in which a plurality of encoding tables are stored in advance in the encoding unit 16 and the decoding unit 17. In this case, an identifier of an encoding table to be used is stored in the encoding header FCH, and the normal-time encoded data FCD may be battery data encoded by the encoding table.

The transmission data in the abnormal mode includes an abnormal-time encoding header FIC and an abnormal-time encoded data FID subsequent to the communication header FH. The abnormal-time encoding header FIC is information, such as a data type and a data length, necessary for interpreting the abnormal-time encoded data FID. The abnormal-time encoded data FID is obtained when the battery data is encoded by using the abnormal-time encoding header FIC. The type of data is, for example, information indicating voltages of all cells included in the cell group CG, and either the maximum voltage or the minimum voltage in the cell group CG. In FIG. 2, the transmission data excluding the communication header FH is the encoded data.

In the present embodiment, a combination of encoding in the normal mode and encoding in the abnormal mode can be freely selected, and an enormous combination can be considered. The restriction of the encoding in the two modes in the present embodiment is that the encoded data in the abnormal mode has a shorter data length than the encoded data in the normal mode. However, the length of data mentioned here is the size of data in the application layer of the OSI reference model, and is not the size of each packet (also referred to as datagram or frame) of the second layer or the third layer in the OSI reference is model. In the present embodiment, when an abnormality detected in the transmission path T, it is intended to reduce the data so that the information of the cell can be easily reached although the amount of information is reduced.

### (Flowchart)

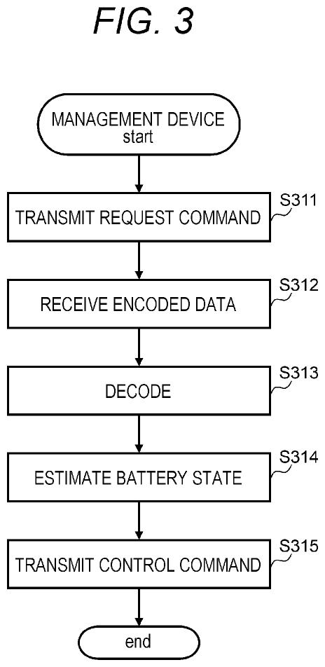

FIG. 3 is a flowchart illustrating an operation of the management device M. The management device M executes the processing illustrated in FIG. 3 every time a predetermined time, for example, 20 ms elapses. Note that in FIG. 3, transmission and reception of data between the management device M and one battery data transmission device B will be described. The management device M executes the processing illustrated in FIG. 3 as many times as the number of battery data transmission devices B included in the transmission system S1.

In step S311, the battery controller 19 generates a request command for the specific battery data transmission device B, and transmits the request command by using the transmission control unit 15-3. As described above, the request command includes information designating the encoding mode. According to the recent detection result by the abnormality detection unit 18, the battery controller 19 includes, in the request command, designation of the encoding mode indicating either the normal mode or the abnormal mode. Specifically, information indicating the normal mode is included in a case where the recent detection result of the transmission target battery data transmission device B is normality, and information indicating the abnormal mode is included in a case where the recent detection result of the transmission target battery data transmission device B is abnormality.

In subsequent step S312, the battery controller 19 receives the encoded data from the battery data transmission device B. In subsequent step S313, the battery controller 19 decodes the encoded data by using the decoding unit 17. In subsequent step S314, the battery controller 19 estimates a battery state. In subsequent step S315, the battery controller 19 transmits a control command to the cell controller 14 on the basis of at least one of the battery state estimated in step S314 or the command from the host controller 20, and ends the processing illustrated in FIG. 3.

As described above, in step S311, when the abnormality detection unit 18 detects the abnormality of the transmission path T immediately before, the battery controller 19 transmits, to the battery data transmission device B, a request command including a command to set the encoding mode to the abnormal mode. It can also be said that the command to set the encoding mode to the abnormal mode is a command to shorten the data length of the encoded data. Therefore, it can be said that the battery controller 19 has a role as a “command unit” that outputs a command to shorten the data length of the encoded data.

Note that although not illustrated in FIG. 3, in a case where the abnormality detection unit 18 detects an abnormality or a case where sensor data cannot be obtained from the battery data transmission device B determined to be in the abnormal mode, the management device M may notify the host controller 20 that an abnormality has occurred in the battery of the transmission system S1.

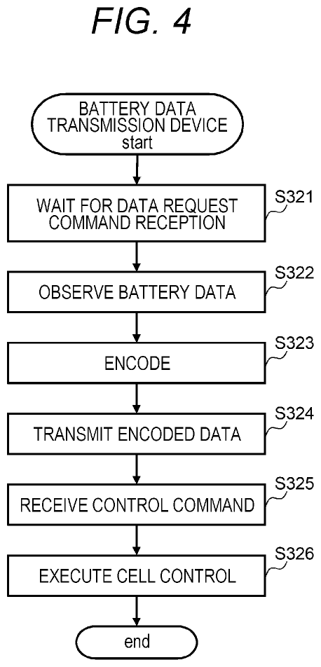

FIG. 4 is a flowchart illustrating an operation of the battery data transmission device B. When activated, the battery data transmission device B performs the operation illustrated in FIG. 4, and when the operation illustrated in FIG. 4 is completed, the battery data transmission device B performs the operation illustrated in FIG. 4 again. That is, the battery data transmission device B repeatedly executes the operation illustrated in FIG. 4.

In step S321, the battery data transmission device B waits for reception of the request command from the battery data transmission device B, and when receiving the request command, the process proceeds to step S322. As described above, the received request command includes information designating the encoding mode, specifically, information designating either the normal mode or the abnormal mode. Note that the request command received in this step is transmitted in step S311 in FIG. 3.

In step S322, the cell controller 14 observes battery data, that is, acquires battery information. In subsequent step S323, the cell controller 14 causes the encoding unit 16 to encode the battery data by designating the encoding mode. The encoding mode designated by the cell controller 14 in this step is the encoding mode designated in the request command received in step S321.

In subsequent step S324, the transmission control unit 15 transmits the encoded data, which is the battery data encoded by the encoding unit 16, to the management device M. Note that this encoded data is received in step S312 of FIG. 3. In subsequent step S325, the battery data transmission device B receives the control command from the management device M. The request command received in this step is transmitted in step S315 in FIG. 3. In subsequent step S325, the cell controller 14 executes cell control according to the control command received in step S325, and ends the processing illustrated in FIG. 4.

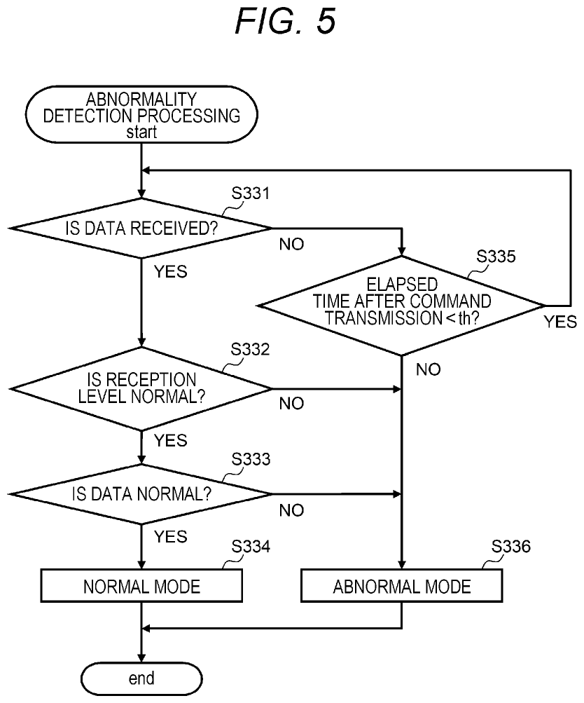

FIG. 5 is a flowchart illustrating abnormality detection processing by the abnormality detection unit 18. When the management device M transmits a request command to the battery data transmission device B, the abnormality detection unit 18 starts the operation illustrated in FIG. 5. For example, when the management device M transmits a request command to each of the 10 battery data transmission devices B, the management device M starts the operation of FIG. 5 corresponding to each of the battery data transmission devices B to which the request command is transmitted. In other words, the processing of the flowchart illustrated in FIG. 5 is executed for any specific battery data transmission device B. In the description of this flowchart, the battery data transmission device B to be executed is referred to as a “corresponding battery data transmission device B”.

In step S331, the abnormality detection unit 18 determines whether or not the encoded data has been received from the corresponding battery data transmission device B. In a case where it is determined that the encoded data is received from the corresponding battery data transmission device B, the abnormality detection unit 18 proceeds to step S332, and in a case where it is determined that the encoded data is not received from the corresponding battery data transmission device B, the abnormality detection unit 18 proceeds to step S335. In step S332, the abnormality detection unit 18 determines whether or not the reception level of communication with the corresponding battery data transmission device B is normal. The communication to be evaluated in this step may be communication at the time of receiving encoded data or communication in initialization of wireless communication or the like. In a case where it is determined that the reception level of the communication with the corresponding battery data transmission device B is normal, the abnormality detection unit 18 proceeds to step S333, and in a case where it is determined that the reception level of the communication with the corresponding battery data transmission device B is not normal, the abnormality detection unit 18 proceeds to step S336.

In step S333, the abnormality detection unit 18 determines whether or not the data received from the corresponding battery data transmission device B is normal. The abnormality detection unit 18 applies a known error detection method (for example, CRC) to the data received from the corresponding battery data transmission device B. In a case where it is determined that the data is normal, the abnormality detection unit 18 proceeds to step S334, and in a case where it is determined that the data received from the corresponding battery data transmission device B is not normal, the abnormality detection unit 18 proceeds to step S336.

In step S334, the abnormality detection unit 18 decides, as the normal mode, the encoding mode to be designated next for the corresponding battery data transmission device B, and ends the processing illustrated in FIG. 5. In step S335, the abnormality detection unit 18 determines whether or not the elapsed time after transmission of the request command is shorter than a predetermined threshold th. In a case where it is determined that the elapsed time after transmission of the request command is shorter than the predetermined threshold th, the abnormality detection unit 18 returns to step S331, and in a case where it is determined that the elapsed time after transmission of the request command is equal to or longer than the predetermined threshold th, the abnormality detection unit 18 proceeds to step S336. In step S336, the abnormality detection unit 18 decides, as the abnormal mode, the encoding mode to be designated next for the corresponding battery data transmission device B, and ends the processing illustrated in FIG. 5.

According to the first embodiment described above, the following operational effects can be obtained.

(1) The management device M includes: a transmission control unit 15-z that communicates with a battery data transmission device B that transmits encoded data, which is obtained by encoding battery data which is data regarding a battery, via a transmission path T; an abnormality detection unit 18 that detects an abnormality of the transmission path T, and a battery controller 19 that also functions as a command unit that outputs, to the battery data transmission device B, a command to shorten a data length of the encoded data when the abnormality detection unit 18 detects the abnormality of the transmission path T. Therefore, in the data encoding for transmitting the information of the battery, the encoding method is changed between the normal time and the abnormal time, and the transmission of the information can be maintained even in a situation where the transmission error occurs. Specifically, since the data length is short in the abnormal mode, retransmission is facilitated and information is easily transmitted as compared with a case where the data length is long.

(2) The transmission path T is a space for wireless communication.

(3) The abnormality detection unit 18 detects the abnormality by using a time interval at which the encoded data is received from the battery data transmission device B, the number of times of retransmission requests from the battery data transmission device B, a level of a communication signal received from the battery data transmission device B, and a data error in the encoded data. Therefore, the abnormality of the transmission path T can be detected by using various states caused by the occurrence of the abnormality of the transmission path T.

(4) The transmission control unit 15-z communicates with a plurality of battery data transmission devices B. The abnormality detection unit 18 individually detects the abnormality of the transmission path for the plurality of battery data transmission devices B. The battery controller 19 that also operates as the command unit outputs the command to shorten the data length of the encoded data to the battery data transmission device B related to the transmission path for which the abnormality detection unit 18 has detected the abnormality. Therefore, the battery data transmission device B in which the abnormality of the transmission path T is not detected is caused to execute the encoding in the normal mode, and abundant information can be acquired.

(5) The transmission system S1 includes a battery data transmission device B that transmits, via a transmission path T, encoded data obtained by encoding battery data which is data regarding a battery, and a management device M that receives the encoded data. The transmission system S1 includes an abnormality detection unit 18 that detects an abnormality of the transmission path. The battery data transmission device B includes an encoding unit 16 that generates the encoded data by using the battery data, and transmission control units 15-1 to 15-n that transmit the encoded data to the management device via the transmission path T. The encoding unit 16 has at least a normal mode and an abnormal mode as operation modes. The encoded data in the abnormal mode has a data length shorter than a data length of the encoded data in the normal mode. The abnormality detection unit 18 applies the abnormality mode to the encoding unit 16 when detecting the abnormality of the transmission path T.

### (First Modification)

In the first embodiment described above, the abnormality detection unit 18 detects the abnormality of the transmission path T by using all four of the data reception interval, the number of times of retransmission request, the reception level, and the data error. However, it is sufficient if the abnormality detection unit 18 may detect the abnormality of the transmission path T by using at least one of the data reception interval, the number of times of retransmission requests, the reception level, or the data error.

### (Second Modification)

In the first embodiment described above, the cell controller 14 designates the encoding mode for the encoding unit 16. However, the cell controller 14 may not have a function of designating the encoding mode for the encoding unit 16. In this case, the battery data transmission device B includes an encoding mode switching unit that interprets at least a part of the request command received from the management device M and designates the encoding mode for the encoding unit 16.

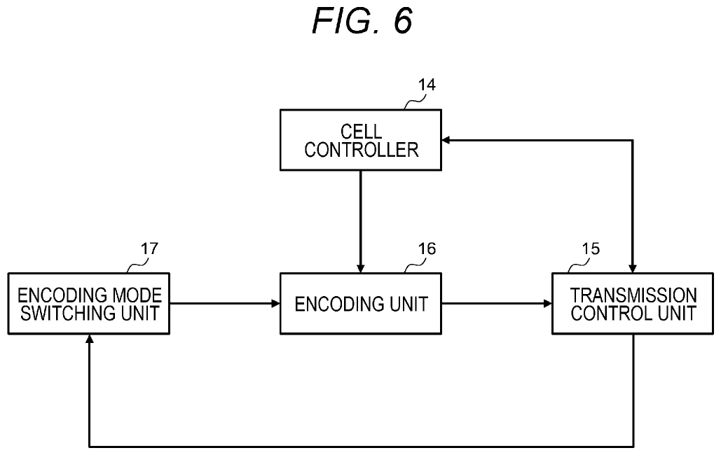

FIG. 6 is a functional configuration diagram of the battery data transmission device B in the present modification. The battery data transmission device B in the present modification includes an encoding mode switching unit 1A in addition to the cell controller 14, the transmission control unit 15, and the encoding unit 16. In the present modification, the transmission control unit 15 transmits a received request command to the cell controller 14 and the decoding unit 17. The operation of the cell controller 14 is similar to that of the first embodiment except that the encoding mode is not transmitted to the encoding unit 16. The decoding unit 17 designates the encoding mode for the encoding unit 16 on the basis of the received request command.

### (Third Modification)

In a case where the abnormal mode is designated as the encoding mode by the management device M, the cell controller 14 may reduce the number of types of data to be transmitted to the encoding unit 16 from that at the normal time. For example, the cell controller 14 may transmit, to the encoding unit 16, information on the voltage and temperature of each cell in the normal mode, and may transmit, to the encoding unit 16, only the voltage of each cell in the abnormal mode. According to the present modification, even if the encoding mode of the encoding unit 16 is not changed between the normal mode and the abnormal mode, the type of data to be transmitted from the cell controller 14 to the encoding unit 16 is reduced, so that the encoded data in the abnormal mode can be easily received.

### (Fourth Modification)

In the first embodiment described above, the abnormality detection unit 18 determines the encoding mode of each battery data transmission device B every time the abnormality detection processing illustrated in FIG. 5 is executed once. However, the abnormality detection unit 18 may add an additional condition to the switching from the abnormality mode to the normal mode. For example, in a case where it is determined that the encoding mode is the abnormal mode, only after the encoding mode is determined to be the normal mode a predetermined number of times, for example, three consecutive times thereafter, the abnormality detection unit 18 designates, as the normal mode, the encoding mode to be included in the request command to be transmitted to the battery data transmission device B. In other words, in step S334 of FIG. 5, only in a case where the normal mode has been selected three or more consecutive times in the last past, the encoding mode included in the request command is designated as the normal mode, and in other cases, the encoding mode included in the request command is designated as the abnormal mode.

Note that the abnormality detection unit 18 may use a condition of a predetermined continuous time instead of the condition of the predetermined number of consecutive times. In this case, in step S334 of FIG. 5, only when the normal mode is continuously selected in the latest predetermined time, for example, 1 hour, the encoding mode included in the request command is designated as the normal mode, and in other cases, the encoding mode included in the request command is designated as the abnormal mode.

### (Fifth Modification)

In the first embodiment described above, the battery controller 19 transmits the request command to the battery data transmission device B. However, the abnormality detection unit 18 may transmit t the request command to the battery data transmission device B. In this case, it can be said that the abnormality detection unit 18 has a role as a “command unit” that outputs a command to shorten the data length of the encoded data. In the present modification, the abnormality detection unit 18 may transmit the request command to each battery data transmission device B every time a predetermined time elapses, or similarly to the first embodiment, the timing of transmitting the request command may be managed by the battery controller 19, and the abnormality detection unit 18 may generate the request command on the basis of the transmission command by the battery controller 19.

### (Sixth Modification)

The abnormality detection unit 18 may evaluate a reception interval, at which the encoded data is received, instead of evaluating the elapsed time after the request command is transmitted. In this case, in step S335 in FIG. 5, it is sufficient if it be determined whether or not the elapsed time from the recent reception of the encoded data is less than the predetermined threshold.

### (Seventh Modification)

In the first embodiment described above, the battery controller 19 individually determines the encoding mode for each battery data transmission device B. However, the battery controller 19 may collectively change the encoding mode of the battery data transmission device B to be connected. In this case, the battery data transmission device B designates the normal mode only in a case where there is no abnormality in all the battery data transmission devices B to be connected, and designates the abnormal mode for all the battery data transmission devices B when an abnormality is detected even in one battery data transmission device B.

### (Eighth Modification)

The transmission path T may be a signal line or a mixture of a signal line and a space. In this case, the transmission control unit 15 supports both wireless communication and wired communication.

### (Ninth Modification)

In a case where the information on the voltage of each cell is included in the encoded data in the normal mode, the abnormality detection unit 18 may detect the abnormality of the cell of the battery by using the battery data decoded by the decoding unit 17. For example, the abnormality detection unit 18 can determine the normality of the cell on the basis of whether or not the voltage of each cell is included in a predetermined range. In this case, not only in a case where the abnormality detection unit 18 detects an abnormality in the transmission path T but also in a case where an abnormality of the battery is detected, the battery controller 19 transmits, to the battery data transmission device B, a request command including a signal designating the abnormality mode as the encoding mode.

According to the present modification, the following operational effects can be obtained.

(6) The management device M includes a decoding unit 17 that decodes the encoded data to obtain the battery data. The abnormality detection unit 18 detects an abnormality of the battery by using the battery data decoded by the decoding unit 17. When the abnormality detection unit 18 detects the abnormality of the transmission path T or the battery, the battery controller 19 that also operates as the command unit outputs the command to shorten the data length of the encoded data to the battery data transmission device B. Therefore, even in a case where there is an abnormality in the battery, the reliability of the information transmission can be prioritized over the abundance of information.

### Second Embodiment

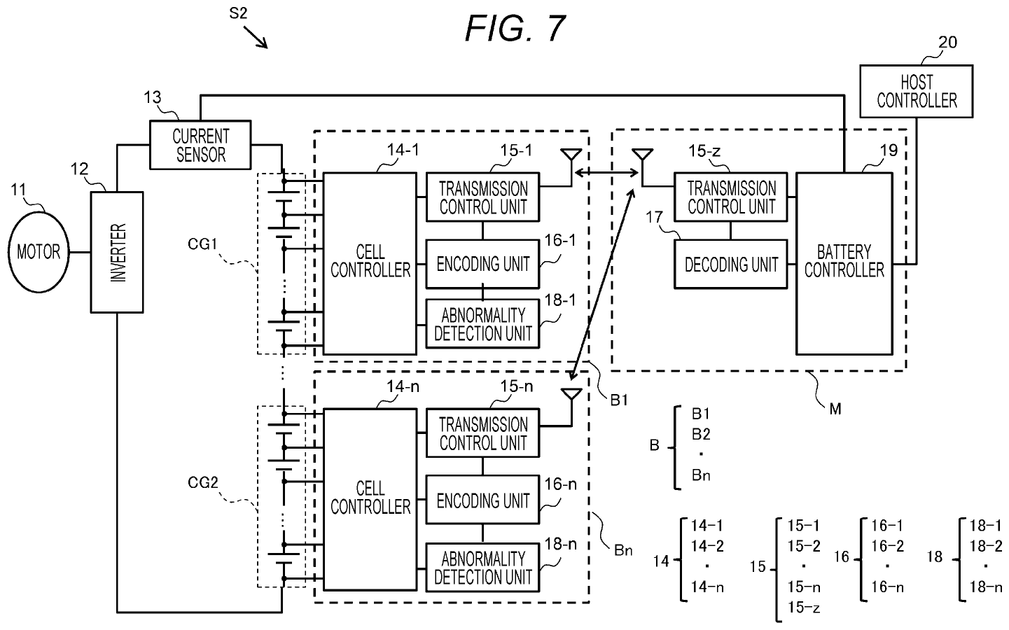

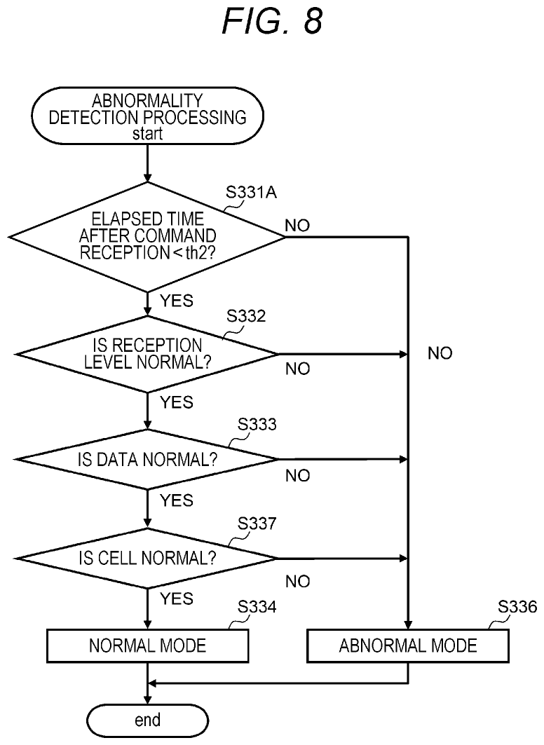

A second embodiment of the transmission system will be described with reference to FIGS. 7 to 8. In the following description, the same components as those of the first embodiment are denoted by the same reference numerals, and differences will be mainly described. The points not particularly described are the same as those in the first embodiment. The present embodiment is different from the first embodiment mainly in that the abnormality detection unit is provided in the battery data transmission device.

FIG. 7 is an overall configuration diagram of a transmission system S2 in the second embodiment. In the present embodiment, the management device M does not include the abnormality detection unit 18, and the battery data transmission device B includes the abnormality detection unit 18.

In the present embodiment, the request command transmitted by the management device M does not include information designating the encoding mode. The cell controller 14 determines the encoding mode on the basis of not the information included in the request command but the detection result of the abnormality detection unit 18 included in the battery data transmission device B to which the cell controller 14 belongs. Specifically, the cell controller 14-1 operates according to the encoding mode determined by an abnormality detection unit 18-1. A cell controller 14-n operates according to the encoding mode determined by an abnormality detection unit 18-n.

FIG. 8 is a flowchart illustrating processing of the abnormality detection unit 18 in the second embodiment. Compared to the operation of the abnormality detection unit 18 in the first embodiment, the operation in the second embodiment is different in that step S331 is changed to step S331A and step S337 is added.

In step S331A, the abnormality detection unit 18 determines whether or not the elapsed time since the battery data transmission device B last received the request command from the management device M is shorter than a predetermined threshold th2. This threshold is, for example, a prescribed time interval at which the management device M transmits a request command to each battery data transmission device B. The abnormality detection unit 18 proceeds to step S332A in a case where it is determined that the elapsed time is shorter than the threshold th2, and proceeds to step S336 in a case where it is determined that the elapsed time is equal to or longer than the threshold th2.

Since the operations in steps S332 and S333 are similar to those in the first embodiment, the description thereof will be omitted. When an affirmative determination is made in step S333, the abnormality detection unit 18 proceeds to step S337. In step S337, by using various pieces of information regarding the cell group CG acquired by the cell controller 14, the abnormality detection unit 18 determines whether or not each cell is normal. The abnormality detection unit 18 proceeds to step S334 in a case where it is determined that all the cells are normal, and proceeds to step S336 in a case where it is determined that at least one cell is not normal. Various known methods can be used to determine the normality of the cell by the abnormality detection unit 18. For example, the abnormality detection unit 18 may determine the normality of the cell on the basis of whether or not the voltage of each cell is included in a predetermined range, or may determine the normality of the cell on the basis of whether or not a correlation between the temporal change of the voltage and the temporal change of the current of each cell satisfies a predetermined relational expression.

According to the second embodiment described above, the following operational effects can be obtained.

(7) A battery data transmission device B includes: an encoding unit 16 that generates encoded data obtained by encoding battery data that is data regarding a battery;

transmission control units 15-1 to 15-n that transmit the encoded data to a management device M via a transmission path T; and an abnormality detection unit 18 that detects an abnormality of the transmission path T. The encoding unit 16 includes at least a normal mode and an abnormal mode as operation modes. The encoded data in the abnormal mode has a data length shorter than a data length of the encoded data in the normal mode. The abnormality detection unit 18 applies the abnormality mode to the encoding unit 16 when detecting the abnormality of the transmission path T.

(8) The encoding unit 16 performs compression processing of compressing the battery data into encoded data having a data length equal to or less than a data length of the battery data.

### Modification of Second Embodiment

The management device M may include information of a request interval, which is a time interval until the next request command is transmitted, in the request command transmitted to each battery data transmission device B. In this case, the abnormality detection unit 18 may set the threshold in step S331A to be the request interval included in the request command, or may set the threshold to be the time obtained by adding a predetermined margin to the request interval.

### Third Embodiment

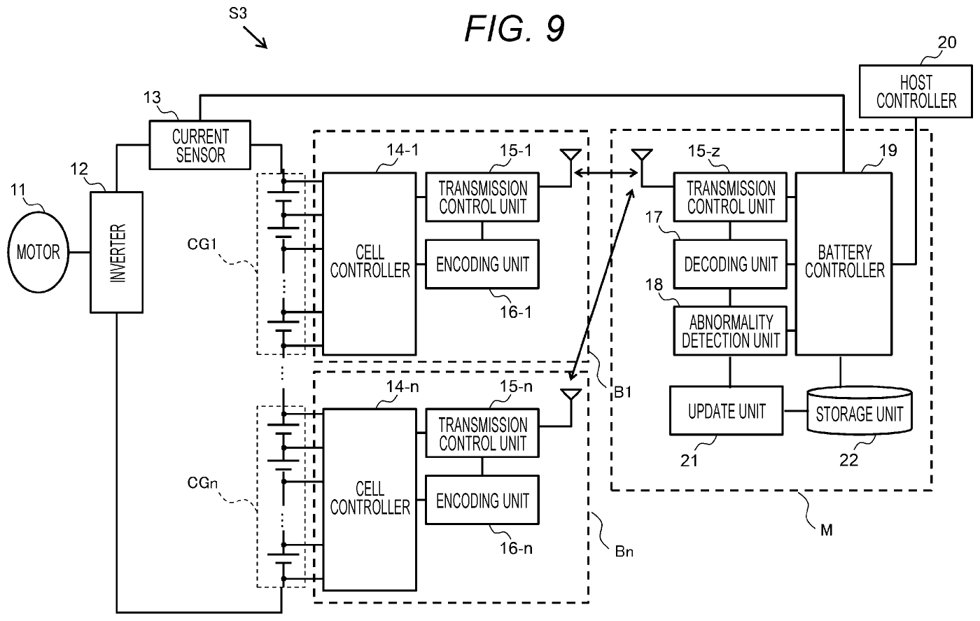

A third embodiment of the transmission system will be described with reference to FIG. 9. In the following description, the same components as those of the first embodiment are denoted by the same reference numerals, and differences will be mainly described. The points not particularly described are the same as those in the first embodiment. The present embodiment is different from the first embodiment mainly in that tables used for encoding and decoding are updated.

FIG. 9 is an overall configuration diagram of a transmission system S3 in the third embodiment. The management device M in the present embodiment includes an update unit 21 and a storage unit 22 in addition to the configuration of the first embodiment. The battery data decoded by the decoding unit 17 is stored in the storage unit 22. In the present embodiment, the decoding unit 17 may output the battery data obtained by decoding not only to the battery controller 19 but also to the storage unit 22, or the battery controller 19 may store the battery data acquired from decoding unit 17 in the storage unit 22. In addition, in the present embodiment, the encoding unit 16 and the decoding unit 17 perform encoding and decoding by using the same encoding table.

When the vehicle on which the transmission system S3 is mounted is stopped, the update unit 21 creates a more efficient encoding table by using the past battery data stored in the storage unit 22. For example, the encoding table is updated such that data having a higher appearance frequency can be expressed with a smaller number of bytes. The update unit 21 stores the created encoding table in the decoding unit 17. The update unit 21 further causes the transmission control unit 15-z to transmit the created encoding table to the battery data transmission device B. The battery data transmission device B having receiving this updates the encoding table stored in the encoding unit 16 to the received encoding table.

According to the third embodiment described above, the following operational effects can be obtained.

(9) The management device M includes a decoding unit 17 that, by using an encoding table, decodes the encoded data to obtain the battery data; a storage unit 22 that accumulates the battery data; and an update unit 21 that updates the encoding table by using the battery data accumulated in the storage unit 22. The transmission control unit 15-z sends the encoding table updated by the update unit 21 to the battery data transmission device B. Therefore, the encoding efficiency can be improved by using the actual data.

### Fourth Embodiment

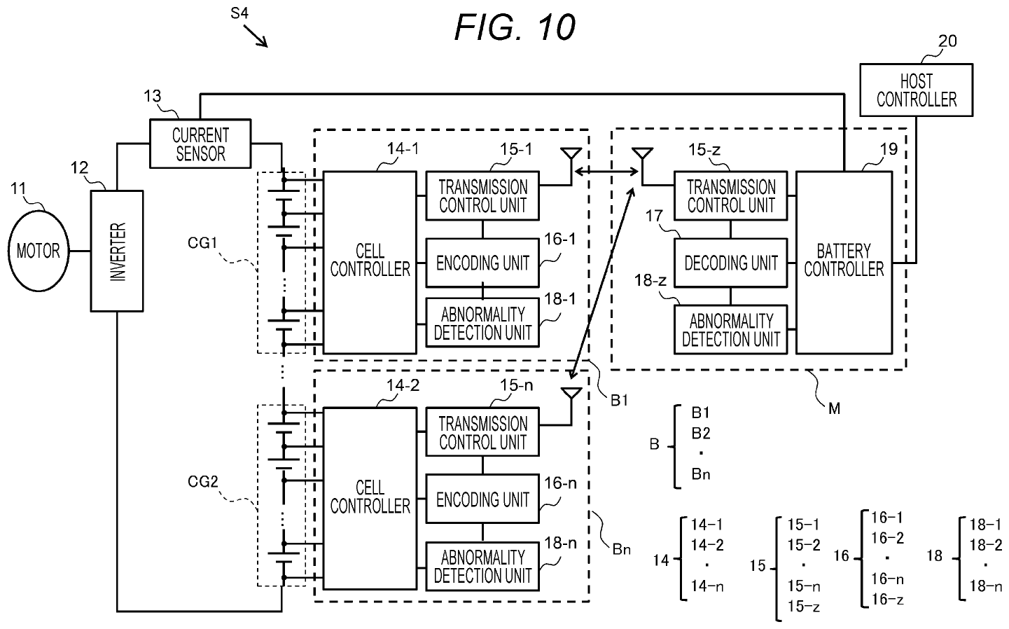

A fourth embodiment of the transmission system will be described with reference to FIG. 10. In the following description, the same components as those of the first embodiment are denoted by the same reference numerals, and differences will be mainly described. The points not particularly described are the same as those in the first embodiment. The present embodiment is different from the first embodiment mainly in that the abnormality detection unit is provided in both the management device and the battery data transmission device.

FIG. 10 is an overall configuration diagram of a transmission system S4 in a fourth embodiment. In the transmission system S4, the management device M in the first embodiment and the battery data transmission device B in the second embodiment are combined. The transmission system S4 in the present embodiment may operate similarly to the transmission system S1 in the first embodiment, or may operate similarly to the transmission system S2 in the second embodiment.

In the above-described embodiments and modifications, the configuration of the functional block is merely an example. Some functional configurations illustrated as separate functional blocks may be integrally configured, a or configuration illustrated in one functional block diagram may be divided into two or more functions. In addition, some of the functions of each functional block may be included in another functional block.

The embodiments and modifications described above may be combined with each other. Although various embodiments and modifications have been described above, the present invention is not limited to these contents. Other embodiments considered within the scope of the technical idea of the present invention are also included within the scope of the present invention.

### REFERENCE SIGNS LIST

14 cell controller
15 transmission control unit
16 encoding unit
17 decoding unit
18 abnormality detection unit
19 battery controller
B battery data transmission device
M management device
S1 to S4 transmission system
T transmission path

1. A management device comprising:
a transmission control unit that communicates with a battery data transmission device that transmits encoded data, which is obtained by encoding battery data which is data regarding a battery, via a transmission path;
an abnormality detection unit that detects an abnormality of the transmission path; and
a command unit that outputs, to the battery data transmission device, a command to shorten a data length of the encoded data when the abnormality detection unit detects the abnormality of the transmission path.

2. The management device according to claim 1, wherein the transmission path is a space for wireless communication.

3. The management device according to claim 1, wherein the abnormality detection unit detects the abnormality by using at least one of a time interval at which the encoded data is received from the battery data transmission device, the number of times of retransmission requests from the battery data transmission device, a level of a communication signal received from the battery data transmission device, or a data error in the encoded data.

4. The management device according to claim 1, further comprising a decoding unit that decodes the encoded data to obtain the battery data,
wherein the abnormality detection unit further detects an abnormality of the battery by using the battery data decoded by the decoding unit, and
the command unit outputs, to the battery data transmission device, the command to shorten the data length of the encoded data when the abnormality detection unit detects the abnormality of the transmission path or the battery.

5. The management device according to claim 1, wherein
the transmission control unit communicates with a plurality of the battery data transmission devices,
the abnormality detection unit individually detects the abnormality of the transmission path for the plurality of battery data transmission devices, and
the command unit outputs the command to shorten the data length of the encoded data to the battery data transmission device related to the transmission path for which the abnormality detection unit has detected the abnormality.

6. The management device according to claim 1, further comprising:
a decoding unit that, by using an encoding table, decodes the encoded data to obtain the battery data;
a storage unit that accumulates the battery data; and
an update unit that updates the encoding table by using the battery data accumulated in the storage unit,
wherein the transmission control unit sends the encoding table updated by the update unit to the battery data transmission device.

7. A battery data transmission device comprising:
an encoding unit that generates encoded data obtained by encoding battery data which is data regarding a battery;
a transmission control unit that transmits the encoded data to a management device via a transmission path; and
an abnormality detection unit that detects an abnormality of the transmission path,
wherein the encoding unit has at least a first mode and a second mode as operation modes,
the encoded data in the second mode has a data length shorter than a data length of the encoded data in the first mode, and
the abnormality detection unit applies the second mode to the encoding unit when detecting the abnormality of the transmission path.

8. The battery data transmission device according to claim 7, wherein the encoding unit performs compression processing of compressing the battery data into encoded data having a data length equal to or less than a data length of the battery data.

9. The battery data transmission device according to claim 7, wherein the transmission path is a space for wireless communication.

10. The battery data transmission device according to claim 7, further comprising a cell controller that outputs the battery data to the encoding unit when receiving a request command to request the encoded data from the management device,
wherein the abnormality detection unit detects the abnormality by using at least one of an elapsed time from last reception of the request command from the management device, the number of times of retransmission request from the management device, a level of a communication signal received from the management device, or a data error in the request command.

11. The battery data transmission device according to claim 7, further comprising a cell controller that acquires information from the battery,
wherein the abnormality detection unit further detects an abnormality of the battery by using the information acquired by the cell controller, and
the abnormality detection unit applies the second mode to the encoding unit when the abnormality detection unit detects the abnormality of the transmission path or the battery.

12. A transmission system which includes a battery data transmission device that transmits, via a transmission path, encoded data obtained by encoding battery data which is data regarding a battery, and a management device that receives the encoded data, the transmission system comprising an abnormality detection unit that detects an abnormality of the transmission path,
wherein the battery data transmission device includes
an encoding unit that generates the encoded data by using the battery data, and
a transmission control unit that transmits the encoded data to the management device via the transmission path,
the encoding unit has at least a first mode and a second mode as operation modes,
the encoded data in the second mode has a data length shorter than a data length of the encoded data in the first mode, and
the abnormality detection unit applies the second mode to the encoding unit when detecting the abnormality of the transmission path.
